(19) United States
(12) Patent Application Publication
(10) Pub. No.: US 2025/0231794 A1
(43) Pub. Date: Jul. 17, 2025

(54) NETWORK CONFIGURATION INFORMATION PROCESSING METHOD, SDN CONTROLLER, SYSTEM AND STORAGE MEDIUM

(71) Applicant: CLOUD INTELLIGENCE ASSETS HOLDING (SINGAPORE) PRIVATE LIMITED

(72) Inventor: Ningjing HUANG, Hangzhou (CN)

(21) Appl. No.: 18/854,925

(22) PCT Filed: Apr. 14, 2023
(86) PCT No.: PCT/CN2023/088284

§ 371 Date: Oct. 7, 2024

(30) Foreign Application Priority Data
Apr. 29, 2022 (CN) 202210476299.2

(51) Int. Cl. G06F 9/48; G06F 9/455; H04L 41/0803; H04L 41/40

(52) U.S. Cl. CPC G06F 9/4856; G06F 9/45558; H04L 41/0803; H04L 41/40; G06F 2009/4557

(57) ABSTRACT

The present application provides a network configuration information processing method. For the process of virtual machine live migration, a function of delaying deletion of a virtual machine on an original node computer is realized on the network control plane, so that when a node in the network system sends a message for accessing the live migration virtual machine, even if the node does not refresh the corresponding relationship between the live migration virtual machine and the destination node computer, the message for accessing the live migration virtual machine can still be sent to the original node computer for relaying or processing, and the packet loss probability of the message for accessing the live migration virtual machine can be reduced in the process of virtual machine live migration and within a certain period after the virtual machine live migration is completed.

### CROSS-REFERENCE TO RELATED APPLICATIONS

This application is a National Stage of International Application No. PCT/CN2023/088284, filed on Apr. 14, 2023, which claims priority to Chinese Patent Application No. 202210476299.2, filed to China National Intellectual Property Administration on Apr. 29, 2022 and entitled “NETWORK CONFIGURATION INFORMATION PROCESSING METHOD, SDN CONTROLLER, SYSTEM AND STORAGE MEDIUM”, both of which are hereby incorporated by reference in their entireties.

### TECHNICAL FIELD

The present application relates to the field of communication technologies and, in particular, to a network configuration information processing method, an SDN controller, a system and a storage medium.

### BACKGROUND

Virtual machine (VM) live migration refers to the migration of a virtual machine in a running state from one node computer to another, which can also be called virtual machine dynamic migration or real-time migration. Virtual machine live migration can completely preserve the running state of the virtual machine and quickly restore the virtual machine to its original running state, which is user-unperceivable.

The core of the virtual machine live migration is to ensure that the services or applications provided by the virtual machine are not damaged in the process of live migration. Therefore, for the virtual machine live migration at the network level, it is required to inform other nodes on the network that the IP of the node computer where the virtual machine is located has changed. However, in the prior art, after the virtual machine live migration, messages are often lost, which has a negative impact on applications or services.

### SUMMARY

Various aspects of the present application provide a network configuration information processing method, an SDN controller, a system and a storage medium, which are used for reducing a probability that a message is discarded in the process of virtual machine live migration and within a certain period after the virtual machine live migration is completed.

The embodiments of the present application provide a network configuration information processing method, which is suitable for an SDN controller and includes the following steps:
receiving a live migration message provided by a virtual machine management node that a first virtual machine is migrated from a first original node computer to a first destination node computer;
in response to the live migration message, providing a corresponding relationship between the first virtual machine and the first destination node computer to a gateway in a network system, so that a node computer in the network system obtains the corresponding relationship between the first virtual machine and the first destination node computer from the gateway;
delaying sending a configuration information deletion instruction to the first original node computer, so that the first original node computer delays deleting network configuration information of the first virtual machine; and
in a case that a condition for sending the configuration information deletion instruction is met, sending the configuration information deletion instruction to the first original node computer, so that the first original node computer deletes the network configuration information for the first virtual machine.

The embodiments of the present application further provide a network system, which includes a virtual machine management node, an SDN controller, a gateway and a plurality of node computers, where at least one of the plurality of node computers is deployed with a virtual machine, and the SDN controller communicates with the plurality of node computers through the gateway;
the virtual machine management node is configured to: live migrate a first virtual machine on the first original node computer among the at least one node computer to a first destination node computer, where the first destination node computer is another node computer among the plurality of node computers other than the first original node computer; and provide the SDN controller with a live migration message that the first virtual machine is migrated from the first original node computer to the first destination node computer;
the SDN controller is configured to provide a corresponding relationship between the first virtual machine and the first destination node computer to the gateway in the network system in response to the live migration message, so that the plurality of node computers obtains the corresponding relationship between the first virtual machine and the first destination node computer from the gateway;
the SDN controller is further configured to: delay sending a configuration information deletion instruction to the first original node computer, so that the first original node computer delays deleting network configuration information for the first virtual machine; and send the configuration information deletion instruction to the first original node computer in a case that a condition for sending the configuration information deletion instruction is met;
the first original node computer is configured to delete the network configuration information for the first virtual machine according to the configuration information deletion instruction.

The embodiments of the present application further provide an SDN controller, which includes a memory, a processor and a communication component, where the memory is configured to store a computer program;
the processor is coupled to the memory and the communication component and is configured to execute the computer program to perform the steps in the above network configuration information processing method.

The embodiments of the present application further provide a computer-readable storage medium storing computer instructions, when the computer instructions are executed by one or more processors, the one or more processors are caused to perform the steps in the above network configuration information processing method.

In the embodiments of the present application, for the process of virtual machine live migration, a function of delaying the deletion of the virtual machine on the original node computer is realized on the network control plane, so that when a node in the network system sends a message for accessing the live migration virtual machine, even if the node does not refresh the corresponding relationship between the live migration virtual machine and the destination node computer, the message for accessing the live migration virtual machine can still be sent to the original node computer for relaying or processing, and the packet loss probability of the message for accessing the live migration virtual machine can be reduced in the process of virtual machine live migration and within a certain period after the virtual machine live migration is completed, which is beneficial to ensuring that the services provided by the live migration virtual machine are not damaged. On the other hand, the delayed deletion of the virtual machine on the original node computer is controlled on the network control plane and there is no need to modify the network data plane, so it does not need to occupy additional CPU resources of the node computer.

### BRIEF DESCRIPTION OF DRAWINGS

The accompanying drawings illustrated here are used to provide further understanding of the present application and constitute a part of the present application. The illustrative embodiments of the present application and the descriptions thereof are used to explain the present application and do not constitute an undue limitation to the present application.

FIG. 1 is a structural schematic diagram of a network system according to an embodiment of the present application.

FIG. 2 and FIG. 3 are each a schematic diagrams of a process of performing network configuration information processing by the network system according to an embodiment of the present application.

FIG. 4 is a schematic diagram of a process of mistakenly deleting a virtual machine caused by live migration virtual machine relocation.

FIG. 5 and FIG. 6 are each a schematic diagram of a process of solving a problem of mistakenly deleting a virtual machine caused by live migration virtual machine relocation according to an embodiment of the present application.

FIG. 7 is a flowchart diagram of a network configuration information processing method according to an embodiment of the present application.

FIG. 8 is a structural schematic diagram of an SDN controller according to an embodiment of the present application.

### DESCRIPTION OF EMBODIMENTS

In order to make the objectives, technical solutions, and advantages of the present application more clear, the technical solutions of the present application will be described clearly and completely with reference to the specific embodiments of the present application and the accompanying drawings. Apparently, the described embodiments are merely a part rather than all of the embodiments of the present application. All other embodiments acquired by a person of ordinary skill in the art based on the embodiments of the present application without paying creative efforts shall fall within the protection scope of the present application.

As described in the background, when the live migration approach in the prior art is adopted, messages are often lost after virtual machine live migration. According to the research of the inventor, the fundamental cause of packet loss is that there is a time delay between the time when other nodes in the network refresh the IP address of the node computer where the virtual machine is located and the time of live migration, which leads to that in the process of the live migration or within a certain time after the live migration is completed, some nodes in the network suppose that the live migration virtual machine is still deployed on the original node computer, and these nodes continue to send the message for accessing the live migration virtual machine to the original node computer, while in this time, the original node computer cannot process the received message, resulting in the message being discarded, which causes damage to the services or applications.

For the process of virtual machine live migration, a function of delaying the deletion of the virtual machine on the original node computer is realized on the network control plane, so that when a node in the network system sends a message for accessing the live migration virtual machine, even if the node does not refresh the corresponding relationship between the live migration virtual machine and the destination node computer, the message for accessing the live migration virtual machine can still be sent to the original node computer for relaying or processing, and the packet loss probability of the message for accessing the live migration virtual machine can be reduced in the process of virtual machine live migration and within a certain period after the virtual machine live migration is completed, which is beneficial to ensuring that the services provided by the live migration virtual machine are not damaged. On the other hand, the delayed deletion of the virtual machine on the original node computer is controlled on the network control plane and there is no need to modify the network data plane, so it does not need to occupy additional CPU resources of the node computer.

The technical solutions provided by the embodiments of the present application are described in detail in conjunction with the accompanying drawings.

It should be noted that the same sign represents the same object in the accompanying drawings below as well as in the embodiments, therefore, once an object is defined in one of the accompanying drawings or embodiments, no further discussion of the object is required in subsequent accompanying drawings and embodiments.

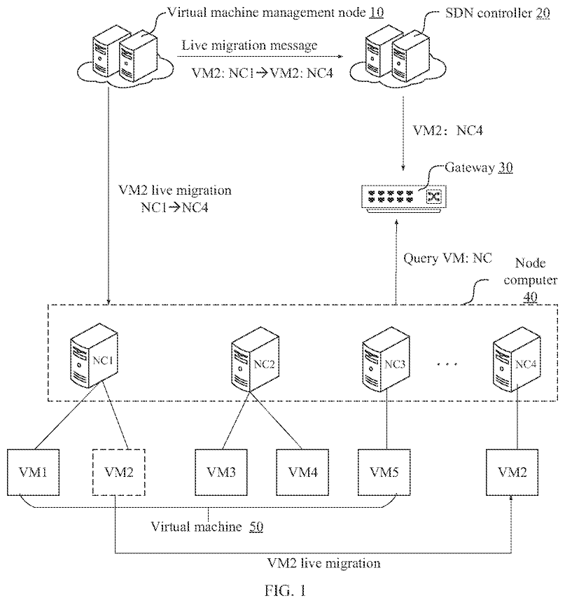

FIG. 1 is a structural schematic diagram of a network system according to an embodiment of the present application. As shown in FIG. 1, the network system includes: a virtual machine management node 10, a Software Defined Network (SDN) controller 20, a gateway 30 and a plurality of node computers (NCs) 40. In the embodiments of the present application, a plurality refers to two or more, and NC is a physical computer. In this embodiment, at least one of the node computers 40 is deployed with a virtual machine (VM) 50. It is illustrated in FIG. 1 that only node computers (NC1-NC3) are deployed with VMs, which is not limited. The SDN controller 20 communicates with the plurality of node computers 40 through the gateway 30.

In this embodiment, the virtual machine management node 10 mainly refers to a computer device that can manage virtual machines, respond to service requests of users, and provide users with services related to virtual machine resource management. In general, the virtual machine management node 10 has the ability to undertake and guarantee services. The virtual machine management node 10 can be implemented as a server device. The server device can be a single server device, a cloud-based server array, or a Virtual Machine (VM) running in the cloud-based server array. In addition, the virtual machine management node 10 can also refer to other computing devices with corresponding service capabilities, for example, a terminal device such as a computer (running service programs).

The SDN controller 20 is an application in the SDN that is responsible for flow control to ensure an intelligent network. The SDN controller is based on a communication protocol such as OpenFlow and allows the server to tell the switch where to send data packets. In the embodiment of the present application, the SDN controller 20 can manage the network configuration information of the virtual machine 50 and is mainly used to configure, delete or update the network configuration information of the virtual machine. The SDN controller 20 can be deployed on a server device. For the implementation form of the server device, reference can be made to the above related content, which will not be repeated here. The SDN controller 20 can be set independently according to the network form. In some embodiments, the network may be a Virtual Private Cloud (VPC) network, and accordingly, the SDN controller 20 may be implemented as a VPC controller.

In the embodiment of the present application, the virtual machine management node 10 can manage the virtual machine 50 and be responsible for the live migration of the virtual machine 50. For example, the virtual machine management node 10 can determine the virtual machine that needs live migration (hereinafter referred to as live migration virtual machine), and select a destination node computer to which the live migration virtual machine is to be migrated from the plurality of node computers. After that, the virtual machine management node 10 can control the live migration virtual machine to migrate from the original node computer to the destination node computer. Specifically, the virtual machine management node 10 can call a virtualization interface to control the live migration virtual machine to migrate from the original node computer to the destination node computer. In FIG. 1, the live migration virtual machine is VM2, the original node computer is NC1, and the destination node computer is NC4.

In the embodiment of the present application, after controlling the live migration virtual machine VM2 to migrate from the original node computer NC1 to the destination node computer NC4, the virtual machine management node 10 can provide the SDN controller 20 with a live migration message that the live migration virtual machine VM2 is migrated from the original node computer NC1 to the destination node computer NC4. The live migration message may include an identification of the live migration virtual machine, an identification of the original node computer and an identification of the destination node computer.

In an implementation, the virtual machine management node 10 can monitor the live migration event through a communication interface with the node computers, and send the live migration message to the SDN controller 20 when the occurrence of the live migration event is monitored.

In response to the live migration message, the SDN controller 20 may provide the corresponding relationship (illustrated as VM2: NC4 in FIG. 1) between the live migration virtual machine VM2 and the destination node computer NC4 to the gateway 30. In an implementation, the SDN controller 20 may obtain the identification of the live migration virtual machine, the identification of the original node computer and the identification of the destination node computer from the live migration message, establish the corresponding relationship between the live migration virtual machine VM2 and the destination node computer NC4 (VM2: NC4) and send the corresponding relationship to the gateway 30. In an implementation, the SDN controller 20 can send the corresponding relationship between the live migration virtual machine VM2 and the destination node computer NC4 to the gateway 30 through a remote application programming interface (API). The SDN controller 20 sends the corresponding relationship between the live migration virtual machine VM2 and the destination node computer NC4 to the gateway 30 quickly, which can reach the order of seconds.

For the node computer 40, it is necessary to obtain the corresponding relationship (VM: NC) between the virtual machine and the node computer by querying the gateway 30, and then refresh the stored corresponding relationship between the virtual machine and the node computer. In an implementation, the node computer 40 may periodically request the corresponding relationship between the virtual machine and the node computer from the gateway 30 according to a set query cycle, and refresh the stored corresponding relationship between the virtual machine and the node computer when the corresponding relationship between the virtual machine and the node computer is changed. The node computer 40 is slow in refreshing the corresponding relationship between the virtual machine and the node computer, and there is a certain delay, and the refreshing speed decreases with the increase of the number of the virtual machine on the node computer 40. Therefore, it is not timely for the node computer to refresh the corresponding relationship between the virtual machine and the node computer, and then the message for accessing the live migration virtual machine continues to be sent to the original node computer. However, the virtual machine has been migrated to the destination node computer, which results in packet loss.

In order to solve the above problems, in some schemes, the frequency that the node computer 40 sends a request to refresh the cache of the corresponding relationship between the virtual machine and the node computer to the gateway 30 can be increased. However, there is an upper limit to increase the refresh frequency, and increasing the refresh frequency will lead to the virtualized network agent on the node computer occupying a high CPU rate of the node computer. The virtualized network agent is mainly used to realize the communication between the virtual network and the physical interface in the node computer. When the number of the virtual machine on the same node computer is large, in order to ensure the performance of the gateway 30, it is necessary to limit the speed of the request that the node computer 40 sends to the gateway 30 to refresh the corresponding relationship between the virtual machine and the node computer, otherwise, the gateway 30 will be congested with traffic and even collapse. However, limiting the speed of the request that the node computer 40 sends to the gateway 30 to refresh the corresponding relationship between the virtual machine and the node computer will lead to a longer delay time for the node computer 40 to refresh the corresponding relationship between the virtual machine and the node computer, so that the packet loss probability of the message for accessing the live migration virtual machine is higher.

In other schemes, the SDN controller 20 may instruct the original node computer NC1 to delete the network configuration information of the live migration virtual machine in response to the live migration message. In the embodiment of the present application, the network configuration information refers to network information required by the virtual machine for network communication, which may include a media access control (MAC) address, an IP address, a network access control list (ACL) and ID information of the virtual machine, etc. When the original node computer receives a message that the SDN controller 20 wants to delete the virtual machine, it can return a deletion failure message to the SDN controller 20. The original node computer can set a timer for the live migration virtual machine to be deleted, and then delete the network configuration information of the virtual machine when the timer exceeds the set delay time, so as to delete the live migration virtual machine. After deleting the live migration virtual machine, the original node computer returns a virtual machine deletion success message to the SDN controller 20. In this scheme, the time for the live migration of the virtual machine becomes longer in the users' view. Moreover, with the increase of the number of the network card in the virtual machine (Vport), the amount of the network configuration information required to be deleted increases, and the actual delay time of deleting the live migration virtual machine also increases linearly, which makes users feel very bad.

In still other embodiments, when the original node computer receives a message or an instruction that the SDN controller 20 wants to delete the VM, it returns a virtual machine deletion success message to the SDN controller 20. The original node computer can set a timer for the live migration virtual machine to be deleted, and then delete the network configuration information of the virtual machine when the timer exceeds the set delay time, so as to delete the live migration virtual machine. In this embodiment of the present application, the SDN controller 20 may send a virtual machine deletion success message to the virtual machine management node 10 when the virtual machine deletion success message returned by the original node computer is received. However, the problem caused by this is that the SDN controller 20 supposes that the original node computer has successfully deleted the live migration virtual machine, and may send the original node computer a creation task for creating a virtual machine with the same parameters as the live migration virtual machine before the timer reaches the delay time. However, because the live migration virtual machine on the original node computer has not been really deleted, the original node computer failed to create the virtual machine, which is incomprehensible to users.

For the above technical problems existing in the method for the network configuration information processing in the process of the virtual machine live migration, in some embodiments of the present application, the SDN controller 20 controls the delayed deletion of the network configuration information of the live migration virtual machine, and the virtual machine management node 10 performs relay configuration on the original node computer. The following is an exemplary explanation of the network configuration information processing mode of the live migration virtual machine in the process of the virtual machine live migration provided by the embodiments of the present application.

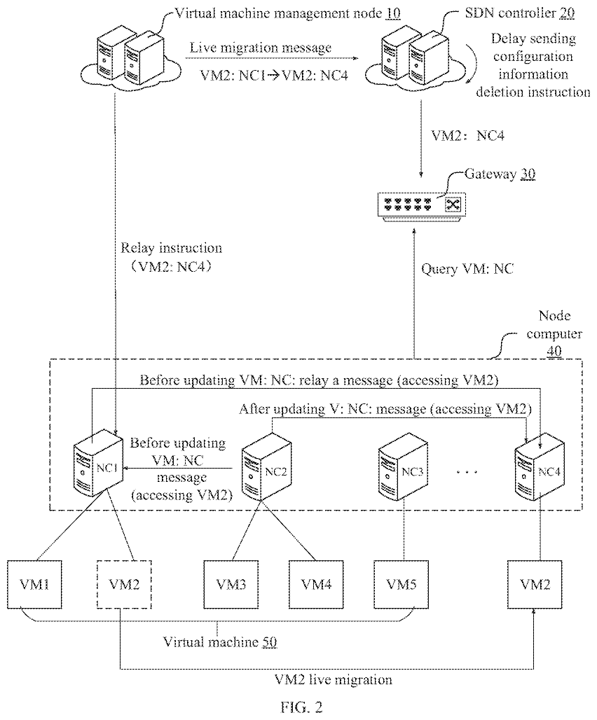

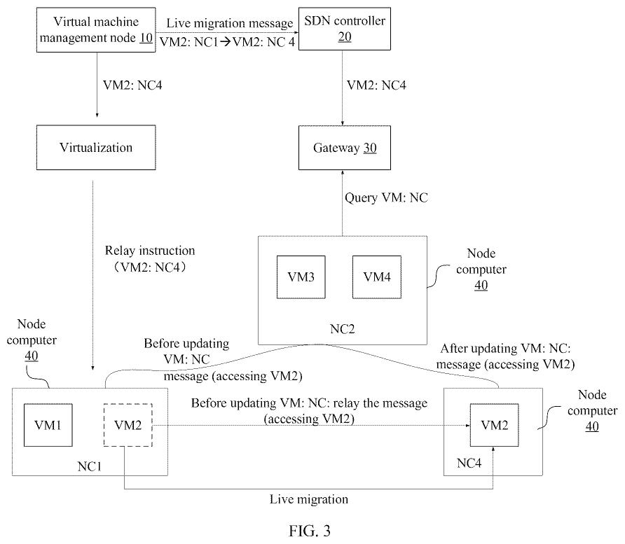

As shown in FIG. 2 and FIG. 3, the SDN controller 20 may delay sending the configuration information deletion instruction to the original node computer NC1, so that the original node computer NC1 delays deleting the network configuration information for the live migration virtual machine VM2. The configuration information deletion instruction is an instruction for instructing the original node computer NC1 to delete the network configuration information of the live migration virtual machine VM2. In an implementation, the SDN controller 20 may return a virtual machine deletion success message to the virtual machine management node 10 when the live migration message is received. In this way, the virtual machine management node 10 can return a virtual machine deletion success message to a user. It is unperceivable for the user to the delayed deletion of the virtual machine on the original node computer NC1, and the overall time for the user to perceive the virtual machine live migration will not be increased.

Specifically, when the SDN controller 20 delays sending the configuration information deletion instruction to the original node computer NC1, it may generate a deletion task based on the live migration message. This deletion task is used to send a configuration information deletion instruction to the original node computer NC1. The configuration information deletion instruction is used to instruct the original node computer to delete the network configuration information corresponding to the network configuration item of the live migration virtual machine.

In an implementation, the SDN controller 20 may obtain the identification of the original node computer NC1 and the identification of the live migration virtual machine VM2 from the live migration message, and generate the deletion task according to the identification of the original node computer NC1 and the identification of the live migration virtual machine VM2, where the deletion task includes the identification of the original node computer NC1 and the identification of the live migration virtual machine VM2. In the embodiment of the present application, an execution time of the deletion task can be set. The time difference between the execution time T2 of the deletion task and the generation time T1 of the deletion task is greater than or equal to the delay duration ΔT of refreshing the corresponding relationship between the virtual machine and the node computer by the plurality of node computers 40 in the network system. In an implementation, the execution time T2 of the deletion task may be determined according to the generation time T1 of the deletion task and the set time delay threshold ΔT. For example, T2=T1+ΔT. The time delay threshold ΔT is an empirical value obtained by technicians through a large number of tests. The time delay threshold ΔT is determined according to the delay duration of refreshing the corresponding relationship between the virtual machine and the node computer by the plurality of node computers 40 in the network system, which can ensure that all node computers in the network system refresh the corresponding relationship between the live migration virtual machine VM2 and the destination node computer NC4.

The SDN controller 20 can execute the deletion task when it reaches the execution time of the deletion task, so as to delay sending the configuration information deletion instruction to the original node computer, and further make the original node computer NC1 delay deleting the network configuration information of the live migration virtual machine VM2. In this way, when another node computer (such as NC2 in FIG. 2 and FIG. 3) sends a message for accessing the live migration virtual machine VM2, the message for accessing the live migration virtual machine VM2 can be sent to the original node computer NC1. In this way, even when the another node computer (such as NC2 in FIG. 2 and FIG. 3) sends a message for accessing the live migration virtual machine VM2, and the another node computer has not refreshed the corresponding relationship between the live migration virtual machine VM2 and the destination node computer NC4, the message for accessing the live migration virtual machine VM2 can be sent to the original node computer NC1 for relaying or processing, which can reduce the packet loss probability of the message for accessing the live migration virtual machine VM2 in the process of the virtual machine live migration.

In the embodiment of the present application, in order to adapt to the virtual machine live migration, when the original node computer NC1 receives the message for accessing the live migration virtual machine VM2, it can relay the message to the destination node computer NC4. In order to realize this function, in the embodiment of the present application, as shown in FIG. 2 and FIG. 3, the virtual machine management node 10 can send a relay instruction to the original node computer NC1 when the live migration virtual machine VM2 starts to migrate from the original node computer NC1 to the destination node computer NC4, or during or after the live migration virtual machine VM2 migrates from the original node computer NC1 to the destination node computer NC4. The original node computer NC1 receives the relay instruction and stores the relay instruction. The relay instruction is used to instruct the original node computer NC1 to relay the message to the destination node computer NC4 when the message for accessing the live migration virtual machine VM2 is received. For the original node computer NC1, the relay instruction will be stored. During the original node computer NC1 stores the relay instruction, when the message for accessing the live migration virtual machine VM2 is received, the original node computer NC1 will relay the message to the destination node computer NC4.

The duration for the original node computer NC1 to store the relay instruction is greater than or equal to the delay duration for the SDN controller 20 to send the configuration information deletion instruction. The relay instruction is deleted after all node computers in the network system refresh the corresponding relationship between the virtual machine and the node computer. In an implementation, the delay duration for the SDN controller 20 to send the configuration information deletion instruction is greater than or equal to the delay duration for the node computer in the network system to obtain the corresponding relationship between the live migration virtual machine VM2 and the destination node computer NC4 from the gateway 30. Therefore, the duration for the original node computer NC1 to store the relay instruction is greater than or equal to the delay duration for the SDN controller 20 to send the configuration information deletion instruction, which can ensure that after the live migration virtual machine VM2 is live migrated from the original node computer NC1 to the destination virtual machine NC4, and before the node computer in the network system obtains the corresponding relationship between the live migration virtual machine VM2 and the destination node computer NC4 from the gateway 30, the original node computer NC1 can relay the received message for accessing the live migration virtual machine VM2 to the destination node computer NC4 according to the relay instruction, which can reduce the packet loss probability of the message for accessing the live migration virtual machine VM2 during this period of time.

In an implementation, the original node computer NC1 can always store the relay instruction, or delete the relay instruction when or after receiving the configuration information deletion instruction sent by the SDN controller 20.

The relay instruction may include the identification of the live migration virtual machine VM2 and the identification of the destination node computer NC4. The message for accessing the live migration virtual machine VM2 may include an IP address of the virtual machine to be accessed. The identification of the live migration virtual machine VM2 can be represented by the IP address of the live migration virtual machine VM2. Of course, the identification of the destination node computer NC4 can also be represented by the IP address of the destination node computer NC4, and so on. Based on the above relay instruction, another node computer (such as the node computer NC2 in FIG. 2 and FIG. 3) can obtain the IP address of the virtual machine to be accessed from the received message. If the IP address of the virtual machine to be accessed is the IP address of the live migration virtual machine VM2, the message is relayed to the destination node computer NC4. In this way, even when the another node computer (such as NC2 in FIG. 2 and FIG. 3) does not refresh the corresponding relationship between the live migration virtual machine VM2 and the destination node computer NC4 when sending the message for accessing the live migration virtual machine VM2, the message for accessing the live migration virtual machine VM2 can still be sent to the original node computer NC1, and the original node computer NC1 relays the message to the destination node computer NC4, which can reduce the packet loss probability of the message for accessing the live migration virtual machine VM2 in the process of the virtual machine live migration.

After another node computer refreshes the corresponding relationship between the live migration virtual machine VM2 and the destination node computer NC4, the another node computer can determine based on the corresponding relationship that the live migration virtual machine VM2 is deployed on the destination node computer NC4, and then it can directly send the message for accessing the live migration virtual machine VM2 to the destination node computer NC4.

In the embodiment of the present application, the SDN controller 20 can not only delay sending the configuration information deletion instruction to the original node computer NC1, but also send the configuration information deletion instruction to the original node computer NC1 when the condition for sending the configuration information deletion instruction is met. The original node computer NC1 can delete the network configuration information of the live migration virtual machine VM2 based on the configuration information deletion instruction, so as to realize the deletion of the live migration virtual machine VM2.

In the embodiment of the present application, the specific implementation form of condition for sending the configuration information deletion instruction is not limited. In some embodiments, the condition for sending the configuration information deletion instruction can be implemented as it reaches the execution time of the deletion task. Accordingly, the SDN controller 20 can determine that the condition for sending the configuration information deletion instruction is met when the current time reaches the execution time of the deletion task. Accordingly, when the current time reaches the execution time of the deletion task, the SDN controller 20 can execute the deletion task, so as to send the configuration information deletion instruction to the original node computer NC1, to delay sending the configuration information deletion instruction to the original node computer NC1. The original node computer NC1 can delete the network configuration information of the live migration virtual machine VM2 based on the configuration information deletion instruction, so as to delete the live migration virtual machine VM2.

In some other embodiments, the condition for sending the configuration information deletion instruction can be realized as that all node computers in the network system complete refreshing the corresponding relationship between the virtual machine and the node computer. Accordingly, the node computer 40 can periodically query the gateway 30 according to the set query frequency to obtain the corresponding relationship between the virtual machine and the node computer from the gateway 30. If the node computer 40 queries that the corresponding relationship between the virtual machine and the node computer in the gateway 30 is different from the corresponding relationship between the virtual machine and the node computer stored in the node computer 40, it obtains the corresponding relationship between the virtual machine and the node computer from the gateway 30 and refreshes the cache corresponding to the corresponding relationship between the virtual machine and the node computer in the node computer 40. Further, the node computer 40 may return a refresh success message to the gateway 30 after the refresh is completed. The gateway 30 may return a refresh success confirmation message to the SDN controller 20 in response to the refresh success message. The SDN controller 20 determines that the condition for sending the configuration information deletion instruction is met in a case that the refresh success confirmation messages of all node computers in the network system are received. Accordingly, the SDN controller 20 can execute the deletion task when the current time reaches the execution time of the deletion task, so as to send the configuration information deletion instruction to the original node computer. The original node computer NC1 can delete the network configuration information of the live migration virtual machine VM2 based on the configuration information deletion instruction, so as to delete the live migration virtual machine VM2.

When the SDN controller 20 sends the configuration information deletion instruction to the original node computer, it can obtain the identification of the original node computer NC1 and the identification of the live migration virtual machine VM2 from the live migration message. After that, the SDN controller 20 can query the corresponding controller database (not shown in the accompanying drawings) to obtain the network configuration information of the live migration virtual machine VM2, and determine the network configuration item to be deleted according to the network configuration information of the live migration virtual machine VM2. Then, the SDN controller 20 can generate the configuration information deletion instruction according to the network configuration item to be deleted. When the configuration information deletion instruction is received, the original node computer NC1 can obtain the identification of the virtual machine to be deleted (that is, the identification of VM2) and the network configuration item to be deleted from the configuration information deletion instruction. In addition, the original node computer NC1 can delete the network configuration information of the virtual machine to be deleted (VM2) that corresponds to the network configuration item to be deleted, so as to delete the virtual machine.

In the embodiment of the present application, for the process of virtual machine live migration, a function of delaying the deletion of the virtual machine on the original node computer is realized on the network control plane, so that when a node in the network system sends a message for accessing the live migration virtual machine, even if the node does not refresh the corresponding relationship between the live migration virtual machine and the destination node computer, the message for accessing the live migration virtual machine can still be sent to the original node computer for relaying or processing, and the packet loss probability of the message for accessing the live migration virtual machine can be reduced in the process of virtual machine live migration, which is beneficial to ensuring that the services provided by the live migration virtual machine are not damaged. On the other hand, the delayed deletion of the virtual machine on the original node computer is controlled on the network control plane and there is no need to modify the network data plane, so it does not need to occupy additional CPU resources of the node computer.

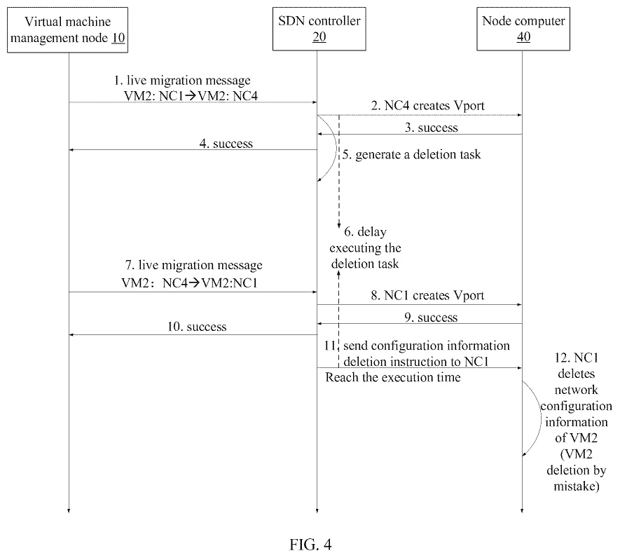

In the embodiment of the present application, for the live migration virtual machine, the case of virtual machine relocation or the case that the virtual machine is live migrated back and forth on two or more node computers may occur. For the case of the relocation of the live migration virtual machine, if the live migration virtual machine is live migrated from the original node computer to the destination node computer, and the live migration virtual machine has been relocated from the destination node computer to the original node computer before the deletion task for delaying the deletion of the live migration virtual machine on the original node computer is executed, the execution of the deletion task will cause the live migration virtual machine on the original node computer to be deleted by mistake. For example, as shown in FIG. 4, after the virtual machine VM2 is live migrated from the original node computer NC1 to the destination node computer NC4, the virtual machine management node 10 sends a live migration message that the virtual machine VM2 is live migrated from the original node computer NC1 to the destination node computer NC4 to the SDN controller 20 (corresponding to step 1 in FIG. 4). The SDN controller 20 may configure network configuration information for the destination node computer NC4 based on the live migration message. As shown in step 2 of FIG. 4, the destination node computer NC4 is instructed to create a virtual network card (Vport), etc. After that, the destination node computer NC4 may return a message that the virtual network card is successfully created to the SDN controller 20 (corresponding to step 3 in FIG. 4), and the SDN controller 20 returns a message that the live migration virtual machine VM2 is successfully created to the virtual machine management node 10 (corresponding to step 4 in FIG. 4).

The SDN controller 20 may generate a deletion task based on the live migration message (corresponding to step 5 in FIG. 4). After that, the SDN controller 20 may delay executing the deletion task (corresponding to step 6 in FIG. 4). The deletion task is used to send a configuration information deletion instruction to the original node computer. In the embodiment of the present application, delaying executing the deletion task means that the deletion task is not executed immediately after it is generated, but is executed only when the condition for executing the deletion task is met. For example, when it reaches the execution time of the deletion task, the deletion task is executed. After the virtual machine VM2 is live migrated from the original node computer NC1 to the destination node computer NC4 and before it reaches the execution time of the deletion task, the virtual machine VM2 is relocated from the destination node computer NC4 to the original node computer NC1 (corresponding to steps 7-10 in FIG. 4). In this way, when it reaches the execution time of the deletion task, the SDN controller 20 executes the deletion task to send the configuration information deletion instruction to the original node computer NC1 (corresponding to step 11 in FIG. 4). The original node computer NC1 may delete the network configuration information of the virtual machine VM2 in response to the configuration information deletion instruction, thereby deleting the virtual machine VM2 (corresponding to step 12 in FIG. 4), resulting in the failure of the virtual machine VM2 relocating to the original node computer NC1 from the destination node computer NC4.

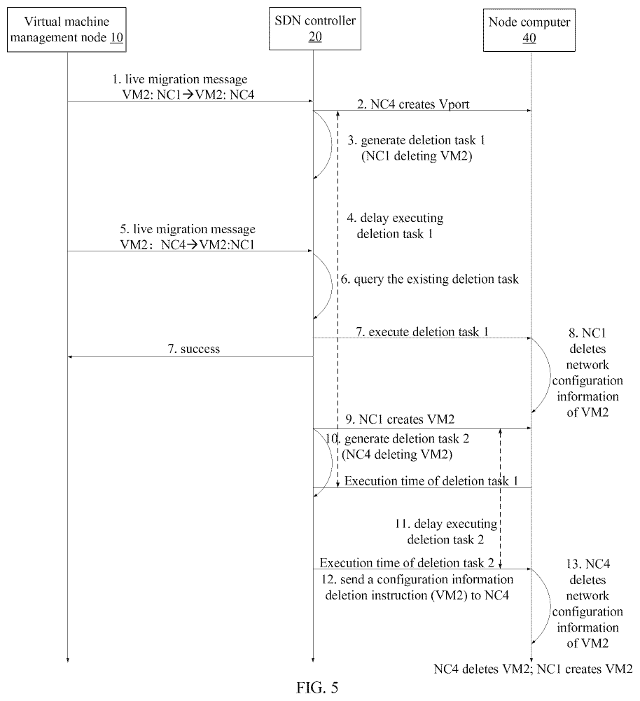

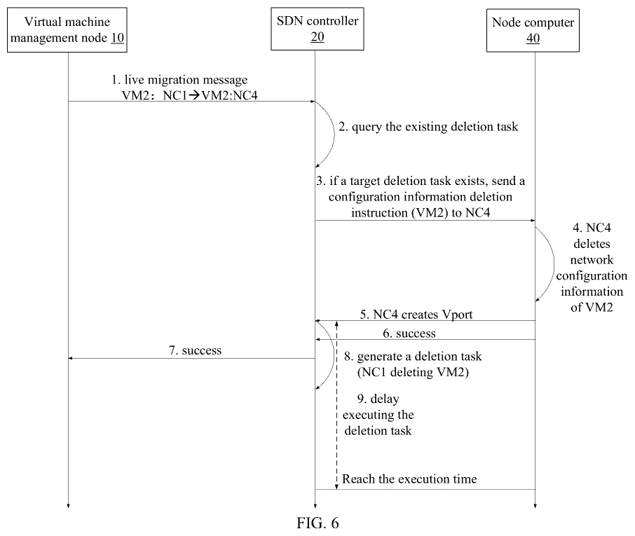

In the embodiment of the present application, in order to solve the problem that the relocated virtual machine is deleted by the deletion task by mistake, the SDN controller 20 can obtain the identification of the node computer NC1 and the network configuration information of the live migration virtual machine VM2 from the live migration message when the live migration message that the live migration virtual machine VM2 is relocated from the node computer NC4 to the original node computer NC1 is received. The live migration virtual machine VM2 can query the existing deletion task (corresponding to step 6 in FIG. 5). If the existing deletion task contains a target deletion task for the node computer NC1 to delete a virtual machine with the same network configuration information as the live migration virtual machine VM2, the target deletion task (that is, the deletion task 1 generated in the process that the live migration virtual machine VM2 is migrated from the node computer NC1 to the destination node computer NC4, corresponding to step 7 in FIG. 5) is directly executed, so that the node computer NC1 deletes the network configuration information of the live migration virtual machine VM2 (corresponding to steps 7 and 8 in FIG. 5). In response to the configuration information deletion instruction, the node computer NC1 can delete the network configuration information of the live migration virtual machine VM2, thereby deleting the live migration virtual machine VM2 (corresponding to step 4 in FIG. 6). Further, the SDN controller 20 can control the node computer NC1 to create the live migration virtual machine VM2 and configure network configuration information for the live migration virtual machine VM2. In this way, even if the virtual machine VM2 is relocated from the node computer NC4 to the node computer NC1, the newly created virtual machine VM2 will not be deleted by mistake because of the execution of the deletion task generated by the previous migration of the virtual machine VM2 from the node computer NC1 to the node computer NC4. Of course, the SDN controller 20 can delay deleting the live migration virtual machine VM2 in the node computer NC4 (corresponding to steps 10-13 in FIG. 5). For a detailed description of this part, please refer to the relevant contents of the above embodiments, which will not be repeated here.

In the embodiment of the present application, it is unnecessary to distinguish whether the live migration message is directed to the first migration of a virtual machine or the virtual machine relocation. In order to solve the problem that the virtual machine is deleted by the deletion task by mistake during relocation, the SDN controller 20 can obtain the identification of the destination node computer NC4 and the network configuration information of the live migration virtual machine VM2 from the live migration message before delaying the execution of the deletion task. If the existing deletion task contains a target deletion task for the destination node computer NC4 to delete a virtual machine with the same network configuration information as the live migration virtual machine VM2, the target deletion task is directly executed without waiting for the reaching of the execution time of the deletion task, so that the destination node computer NC4 deletes the network configuration information of the live migration virtual machine VM2 (corresponding to steps 2-4 in FIG. 6).

In an implementation, the SDN controller 20 can obtain from the existing deletion task an identification of an original node computer and network configuration information of a virtual machine to be deleted by a deletion task that are contained in the existing deletion task (corresponding to step 2 in FIG. 6, querying the existing deletion task). Further, the identification of the destination node computer NC4 can be matched with the identification of the original node computer included in the existing deletion task. If the identification of the destination node computer NC4 exists in the identification of the original node computer included in the existing deletion task, it is determined whether a virtual machine with the same network configuration information as the live migration virtual machine VM2 exists in the virtual machine to be deleted by the deletion task. If the determination result is yes, it is determined that the target deletion task exists in the existing deletion task. Further, the SDN controller 20 can immediately execute the target deletion task to send a configuration information deletion instruction to the node computer (i.e., the destination node computer NC4) corresponding to the target deletion task (corresponding to step 3 in FIG. 6). In response to the configuration information deletion instruction, the destination node computer NC4 may delete the network configuration information of the live migration virtual machine VM2, thereby deleting the live migration virtual machine VM2 (corresponding to step 4 in FIG. 6). In this way, even if the virtual machine VM2 is migrated from the original node computer NC1 to the destination node computer NC4 (relocation of the virtual machine VM2), after the live migration virtual machine VM2 is migrated from the original node computer NC1 to the destination node computer NC4, the newly created virtual machine VM2 will not be deleted by mistake due to the execution of the deletion task generated by the previous migration of the virtual machine VM2 from the node computer NC4 to the node computer NC1.

In a case that the existing deletion task contains a target deletion task for the destination node computer NC4 to delete a virtual machine with the same network configuration information as the live migration virtual machine VM2, the target deletion task can be executed immediately to delete the live migration virtual machine VM2 on the target node computer NC4. After that, the SDN controller 20 can enter a normal virtual machine live migration process, including but not limited to: providing the corresponding relationship between the live migration virtual machine VM2 and the destination node computer NC4 to the gateway 30; delaying sending the configuration information deletion instruction to the original node computer NC1 (corresponding to steps 8 and 9 in FIG. 6), and sending the configuration information deletion instruction to the original node computer NC1 when the condition for sending the configuration information deletion instruction is met, so that the original node computer NC1 deletes the network configuration information for the live migration virtual machine VM2, and so on.

Of course, the virtual machine live migration process may further include that: the SDN controller 20 sends the network configuration information of the live migration virtual machine VM2 to the destination node computer NC4 of the live migration, and the destination node computer NC4 can use the network configuration information to configure the live migration virtual machine VM2 (corresponding to steps 5-7 in FIG. 6).

Specifically, the SDN controller 20 corresponds to a controller database (not shown in the accompanying drawings), where the controller database stores the network configuration information of the virtual machine. When the SDN controller 20 sends the network configuration information of the live migration virtual machine VM2 to the destination node computer NC4, it can obtain the network configuration information of the live migration virtual machine VM2 from the controller database and send the network configuration information to the destination node computer NC4. The destination node computer NC4 can use the network configuration information to perform network configuration on the live migration virtual machine VM2.

In the embodiment of the present application, it is also possible for the SDN controller 20 to update the network configuration of the virtual machine. For example, it is possible to bind a public network IP for the virtual machine, change the MAC address or IP address of the virtual machine, and so on. The SDN controller 20 can store the updated network configuration information of the virtual machine in the controller database. In this way, when the SDN controller 20 performs network configuration on the virtual machine, it can obtain the latest network configuration information from the controller database and send it to the node computer where the virtual machine is located, and the node computer can perform network configuration on the virtual machine with the latest network configuration information, thus ensuring the effectiveness of the network configuration.

In some conventional schemes, when the SDN controller 20 instructs the original node computer NC1 to delete the live migration virtual machine VM2, it is also possible for the SDN controller 20 to obtain the network configuration information of the live migration virtual machine VM2 from the controller database, and determine that the network configuration information obtained from the controller database is the network configuration information to be deleted. Further, the SDN controller 20 may generate a configuration information deletion instruction according to the network configuration information to be deleted. The configuration information deletion instruction is used to instruct the original node computer NC1 to delete the network configuration information to be deleted. In this way, if the SDN controller 20 sends the configuration information deletion instruction to the original node computer NC1, the original node computer NC1 deletes the virtual machine according to the configuration information deletion instruction.

If the network configuration information of the live migration virtual machine VM2 is updated after the live migration virtual machine VM2 is migrated from the original node computer NC1 to the destination node computer NC4, the network configuration information of the live migration virtual machine VM2 stored in the controller database will also be updated accordingly. However, in the embodiment of the virtual machine live migration, the SDN controller 20 will only send the network configuration information to the destination node computer NC4 to which the live migration virtual machine VM2 is migrated, and will not send the network configuration information to the original node computer NC1 where the live migration virtual machine VM2 is located. In this way, the network configuration information of the live migration virtual machine VM2 on the original node computer NC1 is different from that of the live migration virtual machine VM2 in the controller database. In this case, if the SDN controller 20 still obtains the network configuration information of the live migration virtual machine VM2 from the controller database when performing the deletion task, the network configuration information to be deleted in the configuration information deletion instruction is inconsistent with the network configuration information of the live migration virtual machine VM2 on the original node computer NC1, resulting in the failure of the virtual machine deletion.

For example, after the live migration virtual machine VM2 is migrated from the original node computer NC1 to the destination node computer NC4, the SDN controller 20 binds the public network IP for the live migration virtual machine VM2 again or for the first time. The public IP will be updated to the controller database. According to the above conventional scheme, when deleting the live migration virtual machine VM2 of the original node computer NC1, if the configuration information deletion instruction is generated according to the network configuration information of the live migration virtual machine VM2 in the controller database, the configuration of unbinding the public network IP will be sent to the original node computer NC1, but the live migration virtual machine VM2 of the original node computer NC1 is not bound with the public network IP, which will undoubtedly lead to the failure of the virtual machine deletion.

In order to solve the above problem, in the embodiment of the present application, the SDN controller 20 stores a configuration snapshot of the network configuration information before the live migration virtual machine VM2 is migrated from the original node computer NC1 to the destination node computer NC4. The configuration snapshot includes the network configuration information of the live migration virtual machine VM2 before it is migrated from the original node computer NC1 to the destination node computer NC4. In the embodiment of the present application, for the convenience of description and distinction, the network configuration information contained in the configuration snapshot is defined as the first network configuration information, and the network configuration information of the live migration virtual machine VM2 in the controller database is defined as the second network configuration information. The first network configuration information and the second network configuration information may be the same or different. For the case that the SDN controller 20 updates the network configuration information of the live migration virtual machine VM2 after the live migration virtual machine VM2 is migrated from the original node computer NC1 to the destination node computer NC2, the first network configuration information and the second network configuration information are different.

Based on the above configuration snapshot of the live migration virtual machine VM2, when the SDN controller 20 sends a configuration information deletion instruction to the original node computer NC1, it can obtain the first network configuration information from the configuration snapshot of the live migration virtual machine VM2, and determine that the first network configuration information is the network configuration information to be deleted. Further, the SDN controller 20 can generate the configuration information deletion instruction according to the network configuration information to be deleted. The configuration information deletion instruction is used to instruct the original node computer NC1 to delete the network configuration information to be deleted in the live migration virtual machine VM2, that is, to delete the first network configuration information in the configuration snapshot of the live migration virtual machine VM2. When the configuration information deletion instruction is received, the original node computer NC1 can delete the network configuration information to be deleted contained in the instruction according to the configuration information deletion instruction, that is, delete the first network configuration information in the configuration snapshot of the live migration virtual machine VM2. In the network configuration information processing process, the network configuration information of the live migration virtual machine VM2 obtained from the configuration snapshot of the live migration virtual machine VM2 is the network configuration information before the live migration virtual machine VM2 is migrated from the original node computer NC1 to the destination node computer NC4, thus ensuring the consistency of the network configuration information to be deleted contained in the configuration information deletion instruction and the network configuration information of the live migration virtual machine VM2 on the original node computer NC1, thus solving the above problem that the network configuration information of the live migration virtual machine VM2 is updated after the live migration virtual machine VM2 is migrated from the original node computer NC1 to the destination node computer NC4 that results in the failure of the virtual machine deletion.

It should be noted that the configuration information deletion instruction corresponding to the deletion task 1 in FIG. 5 can be generated according to the configuration snapshot of the first network configuration information before the live migration virtual machine VM2 is migrated from the node computer NC1 to the node computer NC4. Therefore, after the live migration virtual machine VM2 is migrated from the node computer NC1 to the node computer NC4 and before the live migration virtual machine VM2 is relocated from the node computer NC4 to the node computer NC1, if the network configuration information of the live migration virtual machine VM2 is updated, and the deletion task 1 is cancelled instead of directly executed, there already exists the network configuration information of the live migration virtual machine VM2 in the node computer NC1, and the SDN controller 20 will no longer configure the network configuration information for the live migration virtual machine VM2 in the node computer NC1, which will cause the network configuration information of the live migration virtual machine VM2 to be the first network configuration information before the migration from the node computer NC1 to the node computer NC4, thus the network configuration information of the live migration virtual machine VM2 in the node computer NC1 cannot be updated timely. Based on this, in the above-mentioned FIG. 5, in a case that the existing deletion task contains a target deletion task for the target node computer NC4 to delete a virtual machine with the same network configuration information as the live migration virtual machine VM2, the target deletion task (that is, the deletion task 1 in FIG. 5) can be directly executed without waiting for the reaching of the execution time of the target deletion task. In this way, when the live migration virtual machine VM2 relocates from the node computer NC4 to the node computer NC1, the SDN controller 20 can configure the live migration virtual machine VM2 in the node computer NC1 with the same network configuration information as in the controller database, that is, configure the latest network configuration information. In addition to the above-mentioned embodiment of the network system, the embodiments of the present application further provide a network configuration information processing method, which will be exemplified from the perspective of the SDN controller with specific embodiments.

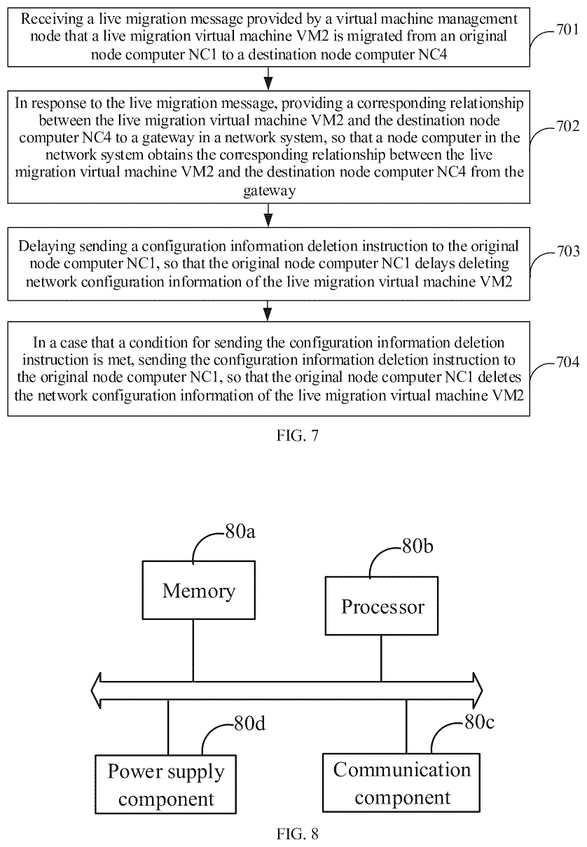

FIG. 7 is a flowchart diagram of a network configuration information processing method according to an embodiment of the present application. The method can be applied to a SDN controller. As shown in FIG. 7, the method mainly includes the following steps.
701, receiving a live migration message provided by a virtual machine management node that a live migration virtual machine VM2 is migrated from an original node computer NC1 to a destination node computer NC4.
702, in response to the live migration message, providing a corresponding relationship between the live migration virtual machine VM2 and the destination node computer NC4 to a gateway in a network system, so that a node computer in the network system obtains the corresponding relationship between the live migration virtual machine VM2 and the destination node computer NC4 from the gateway.
703, delaying sending a configuration information deletion instruction to the original node computer NC1, so that the original node computer NC1 delays deleting network configuration information of the live migration virtual machine VM2.
704, in a case that a condition for sending the configuration information deletion instruction is met, sending the configuration information deletion instruction to the original node computer NC1, so that the original node computer NC1 deletes the network configuration information of the live migration virtual machine VM2.

In the embodiment of the present application, the virtual machine management node can manage the virtual machine and be responsible for the live migration of the virtual machine. For example, the virtual machine management node can determine the virtual machine that needs live migration (hereinafter referred to as live migration virtual machine), and select a destination node computer to which the live migration virtual machine is to be migrated from the plurality of node computers. After that, the virtual machine management node can control the live migration virtual machine to migrate from the original node computer to the destination node computer.

In the embodiment of the present application, after controlling the live migration virtual machine VM2 to migrate from the original node computer NC1 to the destination node computer NC4, the virtual machine management node can provide the SDN controller with a live migration message that the live migration virtual machine VM2 is migrated from the original node computer NC1 to the destination node computer NC4. The live migration message may include an identification of the live migration virtual machine, an identification of the original node computer and an identification of the destination node computer. Accordingly, in step 701, the SDN controller can receive the live migration message.

Further, in step 702, in response to the live migration message, the corresponding relationship between the live migration virtual machine VM2 and the destination node computer NC4 can be provided to the gateway. In an implementation, the identification of the live migration virtual machine, the identification of the original node computer and the identification of the destination node computer can be obtained from the live migration message, the corresponding relationship between the live migration virtual machine VM2 and the destination node computer NC4 (VM2: NC4) can be established and sent to the gateway.

For the node computer, it is necessary to obtain the corresponding relationship (VM: NC) between the virtual machine and the node computer by querying the gateway, and then refresh the stored corresponding relationship between the virtual machine and the node computer. The node computer is slow in refreshing the corresponding relationship between the virtual machine and the node computer, and there is a certain delay, and the refreshing speed decreases with the increase of the number of the virtual machine on the node computer. Therefore, it is not timely for the node computer to refresh the corresponding relationship between the virtual machine and the node computer, and then the message for accessing the live migration virtual machine continues to be sent to the original node computer. However, the virtual machine has been migrated to the destination node computer, which results in packet loss.

In order to solve the above problem, in step 703, the SDN controller may delay sending the configuration information deletion instruction to the original node computer NC1, so that the original node computer NC1 delays deleting the network configuration information for the live migration virtual machine VM2. The configuration information deletion instruction is an instruction for instructing the original node computer NC1 to delete the network configuration information of the live migration virtual machine VM2. In an implementation, the SDN controller may return a virtual machine deletion success message to the virtual machine management node when the live migration message is received. In this way, the virtual machine management node can return a virtual machine deletion success message to a user. It is unperceivable for the user to the delayed deletion of the virtual machine on the original node computer NC1, and the overall time for the user to perceive the virtual machine live migration will not be increased.

Specifically, an implementation of step 703 is to generate a deletion task based on the live migration message. The deletion task is used to send a configuration information deletion instruction to the original node computer NC1. The configuration information deletion instruction is used to instruct the original node computer to delete the network configuration information corresponding to the network configuration item of the live migration virtual machine.

In an implementation, it is possible to obtain the identification of the original node computer NC1 and the identification of the live migration virtual machine VM2 from the live migration message, and generate the deletion task according to the identification of the original node computer NC1 and the identification of the live migration virtual machine VM2, where the deletion task includes the identification of the original node computer NC1 and the identification of the live migration virtual machine VM2. In the embodiment of the present application, an execution time of the deletion task can be set. The time difference between the execution time T2 of the deletion task and the generation time T1 of the deletion task is greater than or equal to the delay duration for the node computer in the network system to obtain the corresponding relationship between the first virtual machine and the first node computer from the gateway.

Since the time difference between the execution time of the deletion task and the generation time T1 of the deletion task is greater than or equal to the delay duration for the node computer in the network system to obtain the corresponding relationship between the first virtual machine and the first destination node computer from the gateway, with the execution of the deletion task, it can be realized to delay sending the configuration information deletion instruction to the original node computer, and further make the original node computer NC1 delay deleting the network configuration information of the live migration virtual machine VM2. In this way, when another node computer sends a message for accessing the live migration virtual machine VM2, the message for accessing the live migration virtual machine VM2 can be sent to the original node computer NC1. In this way, even when the another node computer sends a message for accessing the live migration virtual machine VM2, and the another node computer has not refreshed the corresponding relationship between the live migration virtual machine VM2 and the destination node computer NC4, the message for accessing the live migration virtual machine VM2 can be sent to the original node computer NC1 for relaying or processing, which can reduce the packet loss probability of the message for accessing the live migration virtual machine VM2 in the process of the virtual machine live migration.

In the embodiment of the present application, in order to adapt to the virtual machine live migration, when the original node computer NC1 receives the message for accessing the live migration virtual machine VM2, it can relay the message to the destination node computer NC4. In order to realize this function, in the embodiment of the present application, the virtual machine management node can send a relay instruction to the original node computer NC1 when the live migration virtual machine VM2 starts to migrate from the original node computer NC1 to the destination node computer NC4, or during or after the live migration virtual machine VM2 migrates from the original node computer NC1 to the destination node computer NC4. The relay instruction instructs the original node computer NC1 to relay the message to the destination node computer NC4 when the message for accessing the live migration virtual machine VM2 is received.

For the original node computer NC1, the relay instruction will be stored. During the original node computer NC1 stores the relay instruction, when the message for accessing the live migration virtual machine VM2 is received, the original node computer NC1 will relay the message to the destination node computer NC4. The duration for the original node computer NC1 to store the relay instruction is greater than or equal to the delay duration for the SDN controller to send the configuration information deletion instruction. The relay instruction is deleted after all node computers in the network system refresh the corresponding relationship between the virtual machine and the node computer. In an implementation, the delay duration for the SDN controller to send the configuration information deletion instruction is greater than or equal to the delay duration for the node computer in the network system to obtain the corresponding relationship between the live migration virtual machine VM2 and the destination node computer NC4 from the gateway. Therefore, the duration for the original node computer NC1 to store the relay instruction is greater than or equal to the delay duration for the SDN controller to send the configuration information deletion instruction, which can ensure that after the live migration virtual machine VM2 is live migrated from the original node computer NC1 to the destination virtual machine NC4, and before the node computer in the network system obtains the corresponding relationship between the live migration virtual machine VM2 and the destination node computer NC4 from the gateway, the original node computer NC1 can relay the received message for accessing the live migration virtual machine VM2 to the destination node computer NC4 according to the relay instruction, which can reduce the packet loss probability of the message for accessing the live migration virtual machine VM2 during this period of time.

In an implementation, the original node computer NC1 can always store the relay instruction, or delete the relay instruction when or after receiving the configuration information deletion instruction sent by the SDN controller 20.

The relay instruction may include the identification of the live migration virtual machine VM2 and the identification of the destination node computer NC4. The message for accessing the live migration virtual machine VM2 may include an IP address of the virtual machine to be accessed. The identification of the live migration virtual machine VM2 can be represented by the IP address of the live migration virtual machine VM2. Of course, the identification of the destination node computer NC4 can also be represented by the IP address of the destination node computer NC4, and so on. Based on the above relay instruction, for the received message, the original node computer NC1 can obtain the IP address of the virtual machine to be accessed from the message. If the IP address of the virtual machine to be accessed is the IP address of the live migration virtual machine VM2, the message is relayed to the destination node computer NC4. In this way, even when another node computer does not refresh the corresponding relationship between the live migration virtual machine VM2 and the destination node computer NC4 when sending the message for accessing the live migration virtual machine VM2, the message for accessing the live migration virtual machine VM2 can still be sent to the original node computer NC1, and the original node computer NC1 relays the message to the destination node computer NC4, which can reduce the packet loss probability of the message for accessing the live migration virtual machine VM2 in the process of the virtual machine live migration and within a certain period after the live migration is completed. The certain period after the live migration is completed refers to a delay duration between the migration of the live migration virtual machine VM2 from the original node computer NC1 to the destination node computer NC4 and the refresh of all node computers in the network system to the corresponding relationship between the live migration virtual machine VM2 and the destination node computer NC4.

After another node computer refreshes the corresponding relationship between the live migration virtual machine VM2 and the destination node computer NC4, the another node computer can determine based on the corresponding relationship that the live migration virtual machine VM2 is deployed on the destination node computer NC4, and then it can directly send the message for accessing the live migration virtual machine VM2 to the destination node computer NC4.

In the embodiment of the present application, the SDN controller can not only delay sending the configuration information deletion instruction to the original node computer NC1, but also send the configuration information deletion instruction to the original node computer NC1 when the condition for sending the configuration information deletion instruction is met. The original node computer NC1 can delete the network configuration information of the live migration virtual machine VM2 based on the configuration information deletion instruction, so as to realize the deletion of the live migration virtual machine VM2.

In the embodiment of the present application, the specific implementation form of condition for sending the configuration information deletion instruction is not limited. In some embodiments, the condition for sending the configuration information deletion instruction can be implemented as it reaches the execution time of the deletion task. Accordingly, it can be determined that the condition for sending the configuration information deletion instruction is met when the current time reaches the execution time of the deletion task. Accordingly, when the current time reaches the execution time of the deletion task, the deletion task can be executed, so as to send the configuration information deletion instruction to the original node computer. The original node computer NC1 can delete the network configuration information of the live migration virtual machine VM2 based on the configuration information deletion instruction, so as to delete the live migration virtual machine VM2.

When sending the configuration information deletion instruction to the original node computer, the identification of the original node computer NC1 and the identification of the live migration virtual machine VM2 can be obtained from the live migration message. After that, the SDN controller can query the corresponding controller database to obtain the network configuration information of the live migration virtual machine VM2, and determine the network configuration item to be deleted according to the network configuration information of the live migration virtual machine VM2. Then, the configuration information deletion instruction can be generated according to the network configuration item to be deleted. When the configuration information deletion instruction is received, the original node computer NC1 can obtain the identification of the virtual machine to be deleted (that is, the identification of VM2) and the network configuration item to be deleted from the configuration information deletion instruction. In addition, the original node computer NC1 can delete the network configuration information of the virtual machine to be deleted (VM2) that corresponds to the network configuration item to be deleted, so as to delete the virtual machine.

In the embodiment of the present application, for the process of virtual machine live migration, a function of delaying the deletion of the virtual machine on the original node computer is realized on the network control plane, so that when a node in the network system sends a message for accessing the live migration virtual machine, even if the node does not refresh the corresponding relationship between the live migration virtual machine and the destination node computer, the message for accessing the live migration virtual machine can still be sent to the original node computer for relaying or processing, and the packet loss probability of the message for accessing the live migration virtual machine can be reduced in the process of virtual machine live migration and within a certain period after the virtual machine live migration is completed, which is beneficial to ensuring that the services provided by the live migration virtual machine are not damaged. On the other hand, the delayed deletion of the virtual machine on the original node computer is controlled on the network control plane and there is no need to modify the network data plane, so it does not need to occupy additional CPU resources of the node computer.

In the embodiment of the present application, for the live migration virtual machine, the case of virtual machine relocation or the case that the virtual machine is live migrated back and forth on two or more node computers may occur. For the case of the relocation of the live migration virtual machine, if the live migration virtual machine is live migrated from the original node computer to the destination node computer, and the live migration virtual machine has been relocated from the destination node computer to the original node computer before the deletion task for delaying the deletion of the live migration virtual machine on the original node computer is executed, the execution of the deletion task will cause the live migration virtual machine on the original node computer to be deleted by mistake. For a detailed description, reference can be made to the above related contents of FIG. 4, which will not be repeated here.

In order to solve the problem that the relocated virtual machine is deleted by the deletion task by mistake, the SDN controller can obtain the identification of the destination node computer NC4 and the network configuration information of the live migration virtual machine VM2 from the live migration message before delaying the execution of the deletion task. If the existing deletion task contains a target deletion task for the node computer NC4 to delete a virtual machine with the same network configuration information as the live migration virtual machine VM2, the target deletion task is executed, so that the node computer NC4 deletes the network configuration information of the live migration virtual machine VM2 (corresponding to steps 2-4 in FIG. 6).

In an implementation, it can be obtained from the existing deletion task an identification of an original node computer and network configuration information of a virtual machine to be deleted by a deletion task that are contained in the existing deletion task (corresponding to step 2 in FIG. 6, querying the existing deletion task). Further, the identification of the destination node computer NC4 can be matched with the identification of the original node computer included in the existing deletion task. If the identification of the destination node computer NC4 exists in the identification of the original node computer included in the existing deletion task, it is determined whether a virtual machine with the same network configuration information as the live migration virtual machine VM2 exists in the virtual machine to be deleted by the deletion task. If the determination result is yes, it is determined that the target deletion task exists in the existing deletion task. Further, the SDN controller can immediately execute the target deletion task to send a configuration information deletion instruction to the node computer (i.e., the destination node computer NC4) corresponding to the target deletion task (corresponding to step 3 in FIG. 6). In response to the configuration information deletion instruction, the destination node computer NC4 may delete the network configuration information of the live migration virtual machine VM2, thereby deleting the live migration virtual machine VM2 (corresponding to step 4 in FIG. 6). In this way, even if the virtual machine VM2 is migrated from the original node computer NC1 to the destination node computer NC4 (relocation of the virtual machine VM2), after the live migration virtual machine VM2 is migrated from the original node computer NC1 to the destination node computer NC4, the newly created virtual machine VM2 will not be deleted by mistake due to the execution of the deletion task generated by the previous migration of the virtual machine VM2 from the node computer NC4 to the node computer NC1.

In a case that the existing deletion task contains a target deletion task for the destination node computer NC4 to delete a virtual machine with the same network configuration information as the live migration virtual machine VM2, the target deletion task can be executed immediately to delete the live migration virtual machine VM2 on the target node computer NC4. After that, the SDN controller can enter a normal virtual machine live migration process, including but not limited to: providing the corresponding relationship between the live migration virtual machine VM2 and the destination node computer NC4 to the gateway; delaying sending the configuration information deletion instruction to the original node computer NC1 (corresponding to steps 8 and 9 in FIG. 6), and sending the configuration information deletion instruction to the original node computer NC1 when the condition for sending the configuration information deletion instruction is met, so that the original node computer NC1 deletes the network configuration information for the live migration virtual machine VM2, and so on.

Of course, the virtual machine live migration process may further include that: the SDN controller 20 sends the network configuration information of the live migration virtual machine VM2 to the destination node computer NC4 of the live migration, and the destination node computer NC4 can use the network configuration information to configure the live migration virtual machine VM2 (corresponding to steps 5-7 in FIG. 6).

Specifically, the SDN controller corresponds to a controller database (not shown in the accompanying drawings), where the controller database stores the network configuration information of the virtual machine. When the SDN controller sends the network configuration information of the live migration virtual machine VM2 to the destination node computer NC4, it can obtain the network configuration information of the live migration virtual machine VM2 from the controller database and send the network configuration information to the destination node computer NC4. The destination node computer NC4 can use the network configuration information to perform network configuration on the live migration virtual machine VM2.

In the embodiment of the present application, it is also possible for the SDN controller to update the network configuration of the virtual machine. For example, it is possible to bind a public network IP for the virtual machine, change the MAC address or IP address of the virtual machine, and so on. The SDN controller can store the updated network configuration information of the virtual machine in the controller database. In this way, when the SDN controller performs network configuration on the virtual machine, it can obtain the latest network configuration information from the controller database and send it to the node computer where the virtual machine is located, and the node computer can perform network configuration on the virtual machine with the latest network configuration information, thus ensuring the effectiveness of the network configuration.

In some conventional schemes, when the SDN controller instructs the original node computer NC1 to delete the live migration virtual machine VM2, it is also possible for the SDN controller to obtain the network configuration information of the live migration virtual machine VM2 from the controller database, and determine that the network configuration information obtained from the controller database is the network configuration information to be deleted. Further, the SDN controller may generate a configuration information deletion instruction according to the network configuration information to be deleted. The configuration information deletion instruction is used to instruct the original node computer NC1 to delete the network configuration information to be deleted. In this way, if the SDN controller 20 sends the configuration information deletion instruction to the original node computer NC1, the original node computer NC1 deletes the virtual machine according to the configuration information deletion instruction.

If the network configuration information of the live migration virtual machine VM2 is updated after the live migration virtual machine VM2 is migrated from the original node computer NC1 to the destination node computer NC4, the network configuration information of the live migration virtual machine VM2 stored in the controller database will also be updated accordingly. However, in the embodiment of the virtual machine live migration, the SDN controller will only send the network configuration information to the destination node computer NC4 to which the live migration virtual machine VM2 is migrated, and will not send the network configuration information to the original node computer NC1 where the live migration virtual machine VM2 is located. In this way, the network configuration information of the live migration virtual machine VM2 on the original node computer NC1 is different from that of the live migration virtual machine VM2 in the controller database. In this case, if the SDN controller 20 still obtains the network configuration information of the live migration virtual machine VM2 from the controller database when performing the deletion task, the network configuration information to be deleted in the configuration information deletion instruction is inconsistent with the network configuration information of the live migration virtual machine VM2 on the original node computer NC1, resulting in the failure of the virtual machine deletion.

In order to solve the above problem, in the embodiment of the present application, the SDN controller stores a configuration snapshot of the first network configuration information before the live migration virtual machine VM2 is migrated from the original node computer NC1 to the destination node computer NC4. The configuration snapshot includes the network configuration information of the live migration virtual machine VM2 before it is migrated from the original node computer NC1 to the destination node computer NC4. In the embodiment of the present application, for the convenience of description and distinction, the network configuration information contained in the configuration snapshot is defined as the first network configuration information, and the network configuration information of the live migration virtual machine VM2 in the controller database is defined as the second network configuration information. The first network configuration information and the second network configuration information may be the same or different. For the case that the SDN controller updates the network configuration information of the live migration virtual machine VM2 after the live migration virtual machine VM2 is migrated from the original node computer NC1 to the destination node computer NC2, the first network configuration information and the second network configuration information are different.

Based on the above configuration snapshot of the live migration virtual machine VM2, when the SDN controller sends a configuration information deletion instruction to the original node computer NC1, it can obtain the first network configuration information from the configuration snapshot of the live migration virtual machine VM2, and determine that the first network configuration information is the network configuration information to be deleted. Further, the configuration information deletion instruction can be generated according to the network configuration information to be deleted. The configuration information deletion instruction is used to instruct the original node computer NC1 to delete the network configuration information to be deleted in the live migration virtual machine VM2, that is, to delete the first network configuration information in the configuration snapshot of the live migration virtual machine VM2. When the configuration information deletion instruction is received, the original node computer NC1 can delete the network configuration information to be deleted contained in the instruction according to the configuration information deletion instruction, that is, delete the first network configuration information in the configuration snapshot of the live migration virtual machine VM2. In the network configuration information processing process, the network configuration information of the live migration virtual machine VM2 obtained from the configuration snapshot of the live migration virtual machine VM2 is the network configuration information before the live migration virtual machine VM2 is migrated from the original node computer NC1 to the destination node computer NC4, thus ensuring the consistency of the network configuration information to be deleted contained in the configuration information deletion instruction and the network configuration information of the live migration virtual machine VM2 on the original node computer NC1, thus solving the above problem that the network configuration information of the live migration virtual machine VM2 is updated after the live migration virtual machine VM2 is migrated from the original node computer NC1 to the destination node computer NC4 that results in the failure of the virtual machine deletion.

It should be noted that the execution body of each step of the method provided in the above embodiments can be the same device, or the method can also be executed by different devices. For example, the execution body of steps 702 and 703 may be device A; for another example, the execution body of step 702 may be device A, and the execution body of step 703 may be device B, etc.

In addition, some processes described in the above-mentioned embodiments and the accompanying drawings contain a plurality of operations that appear in a specific order, but it should be clearly understood that these operations may be performed out of the order in which they appear herein or be performed in parallel. The serial numbers of the operations, such as 702 and 703, are only used to distinguish different operations, and the serial numbers themselves do not represent any execution order. In addition, these processes may include more or fewer operations, and these operations may be performed sequentially or in parallel.

Correspondingly, the embodiments of the present application further provides a computer-readable storage medium storing computer instructions, when the computer instructions are executed by one or more processors, the one or more processors are caused to execute the steps in the above network configuration information processing method.

The embodiments of the present application further provides a computer program product, which includes a computer program. When the computer program is executed by one or more processors, the one or more processors are caused to perform the steps in the above network configuration information processing method. In the embodiments of the present application, the specific implementation form of the computer program product is not limited. In some embodiments, the computer program product can be implemented as an SDN controller, or a plug-in of an SDN controller, an application module, etc., but it is not limited thereto.

FIG. 8 is a structural schematic diagram of an SDN controller according to an embodiment of the present application. As shown in FIG. 8, the SDN controller includes a memory 80a, a processor 80b and a communication component 80c. The memory 80a is configured to store a computer program. The processor 80b is coupled to the memory 80a and the communication component 80c and is configured to execute the computer program to: receive through the communication component 80c a live migration message provided by a virtual machine management node that a first virtual machine is migrated from a first original node computer to a first destination node computer; in response to the live migration message, providing through the communication component 80c a corresponding relationship between the first virtual machine and the first destination node computer to a gateway a the network system, so that a node computer in the network system obtains the corresponding relationship between the first virtual machine and the first destination node computer from the gateway; delay sending a configuration information deletion instruction to the first original node computer, so that the first original node computer delays deleting network configuration information of the first virtual machine; in a case that a condition for sending the configuration information deletion instruction is met, sending the configuration information deletion instruction to the first original node computer through the communication component 80c, so that the first original node computer deletes the network configuration information of the first virtual machine.

In an implementation, in the process of delaying sending the configuration information deletion instruction to the first original node computer, the processor 80b is specifically configured to: generate a deletion task based on the live migration message, where a time difference between an execution time of the deletion task and a generation time of the deletion task is greater than or equal to a delay duration for the node computer in the network system to obtain the corresponding relationship between the first virtual machine and the first destination node computer from the gateway; the deletion task is used to send the configuration information deletion instruction to the first original node computer.

In an implementation, the processor 80b is further configured to: determine that the condition for sending the configuration information deletion instruction is met in a case that a current time reaches the execution time of the deletion task. Accordingly, in the process of sending the configuration information deletion instruction to the first original node computer, the processor 80b is specifically configured to: execute the deletion task when the current time reaches the execution time of the deletion task, so as to send the configuration information deletion instruction to the first original node computer through the communication component 80c.

The deletion task includes: an identification of the first original node computer, an identification of the first destination node computer and the network configuration information of the first virtual machine. The processor 80b is further configured to: obtain the identification of the first destination node computer and the network configuration information of the first virtual machine from the live migration message before delaying executing the deletion task; in a case that a target deletion task exists in an existing deletion task, execute the target deletion task, so that the first destination node computer deletes the network configuration information of the first virtual machine; the target deletion task refers to a network configuration information deletion task that instructs the first destination node computer to delete the first virtual machine.

In an implementation, the processor 80b is further configured to: obtain from the existing deletion task an identification of a second original node computer and network configuration information of a second virtual machine contained in the existing deletion task, where the second virtual machine refers to a virtual machine to be deleted by the existing deletion task; in a case that an identification of the second virtual machine contains the identification of the first virtual machine, determine whether a virtual machine with the same network configuration information as the first virtual machine exists in the second virtual machine corresponding to the second original node computer; and if the judgment result is yes, determine that the target deletion task exists in the existing deletion task.

In an implementation, the processor 80b is further configured to: store a configuration snapshot of first network configuration information of the first virtual machine before migrating from the first original node computer to the first destination node computer, where the configuration snapshot includes the first network configuration information. Accordingly, in the process of sending the configuration information deletion instruction to the first original node computer, the processor 80b is specifically configured to: obtain the first network configuration information from the configuration snapshot, determine that the first network configuration information is the network configuration information to be deleted, and generate the configuration information deletion instruction according to the network configuration information to be deleted, so as to instruct the first original node computer to delete the network configuration information to be deleted.

The processor 80b is further configured to: obtain second network configuration information of the first virtual machine from a controller database in response to the live migration message; send the second network configuration information to the first destination node computer so that the first destination node computer performs network configuration on the first virtual machine.

In an implementation, the processor 80b is further configured to: update the network configuration of the first virtual machine to obtain updated network configuration information; determine the updated network configuration information as the second network configuration information; and store the second network configuration information in the controller database.

In the embodiments of the present application, in the process of the live migration of the first virtual machine, the virtual machine management node sends a relay instruction to the first original node computer; the relay instruction is used to instruct the first original node computer to relay a message for accessing the first virtual machine to the first destination node computer when the message for accessing the first virtual machine is received. The first original node computer stores the relay instruction, and relays the message for accessing the first virtual machine received during storing the relay instruction to the first destination node computer.

A duration for the first original node computer to store the relay instruction is greater than or equal to a delay duration for the SDN controller to send the configuration information deletion instruction.

In some implementations, as shown in FIG. 8, the SDN controller may further include components such as a power supply component 80d. Only some components are shown schematically in FIG. 8, which does not mean that the SDN controller must include all the components shown in FIG. 8, nor does it mean that the SDN controller can only include the components shown in FIG. 8.

For the process of virtual machine live migration, the SDN controller provided in this embodiment realizes, on the network control plane, a function of delaying the deletion of the virtual machine on the original node computer, so that when a node in the network system sends a message for accessing the live migration virtual machine, even if the node does not refresh the corresponding relationship between the live migration virtual machine and the destination node computer, the message for accessing the live migration virtual machine can still be sent to the original node computer for relaying or processing, and the packet loss probability of the message for accessing the live migration virtual machine can be reduced in the process of virtual machine live migration and within a certain period after the virtual machine live migration is completed, which is beneficial to ensuring that the services provided by the live migration virtual machine are not damaged. On the other hand, the delayed deletion of the virtual machine on the original node computer is controlled on the network control plane and there is no need to modify the network data plane, so it does not need to occupy additional CPU resources of the node computer.

In the embodiments of the present application, the memory is used for storing a computer program, and can be configured to store various other data to support operations on the device where it is located. The processor can execute the computer program stored in the memory to realize the corresponding control logic. The memory can be implemented by any type of volatile or nonvolatile memory device or their combination, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic disk or optical disk.

In the embodiments of the present application, the processor can be any hardware processing device that can execute the above method logic. In an implementation, the processor can be a Central Processing Unit (CPU), a Graphics Processing Unit (GPU) or a Microcontroller Unit (MCU). It can also be a Field-Programmable Gate Array (FPGA), a Programmable Array Logic (PAL), a General Array Logic (GAL), a Complex Programmable Logic Device (CPLD) or other programmable devices. Or, it can be an advanced reduced instruction set computer (RISC) machines (Advanced RISC Machines, ARM) or a System on Chip (SOC), etc., but is not limited thereto.

In the embodiments of the present application, the communication component is configured to facilitate wired or wireless communication between the device where it is located and other devices. The device where the communication component is located can access the wireless network based on communication standards, such as WiFi, 2G or 3G, 4G, 5G or their combinations. In an exemplary embodiment, the communication component receives a broadcast signal or broadcast related information from an external broadcast management system via a broadcast channel. In an exemplary embodiment, the communication component may also be implemented based on near field communication (NFC) technology, radio frequency identification (RFID) technology, infrared data association (IrDA) technology, ultra-wideband (UWB) technology, Bluetooth (BT) technology or other technologies.

In the embodiments of the present application, the power supply component is configured to provide power for various components of the device where it is located. The power supply component can include a power management system, one or more power supplies and other components associated with generating, managing and distributing power for the device where the power supply component is located.

It should be noted that the descriptions of “first”, “second” and the like in the present application are used to distinguish different messages, devices, modules, etc., which do not represent a sequence, nor do they limit that “first” and “second” are different types.

It should be understood by those skilled in the art that the embodiments of the present application can be provided as a method, a system, or a computer program product. Therefore, the present application can take the form of an entirely hardware embodiment, an entirely software embodiment, or an embodiment combining software with hardware aspects. Moreover, the present application can take the form of a computer program product implemented on one or more computer-usable storage medium (including but not limited to disk storage, CD-ROM, optical storage, etc.) containing computer-usable program codes.

The present application is described with reference to the flowcharts and/or block diagrams of the methods, devices (systems), and computer program products according to the embodiments of the present application. It should be understood that each flow and/or block in the flowcharts and/or block diagrams, and combinations of the flows and/or blocks in the flowcharts and/or block diagrams can be implemented by computer program instructions. These computer program instructions may be provided to a processor of a general-purpose computer, a special-purpose computer, an embedded processor or other programmable data processing devices to produce a machine, such that the instructions which are executed by the processor of the computer or other programmable data processing apparatuses produce apparatuses for implementing the functions specified in a flow or flows of the flowcharts and/or a block or blocks of the block diagrams.

These computer program instructions may also be stored in a computer-readable memory that can direct a computer or other programmable data processing apparatuses to work in a particular manner, such that the instructions stored in the computer-readable memory produce a manufacture product including instruction apparatuses that implements the functions specified in a flow or flows of the flowcharts and/or a block or blocks of the block diagrams.

These computer program instructions can also be loaded onto a computer or other programmable data processing apparatuses, such that a series of operational steps are performed on the computer or other programmable apparatuses to produce a computer-implemented processing, such that the instructions executed on the computer or other programmable apparatuses provide steps for implementing the functions specified in a flow or flows of the flowcharts and/or a block or blocks of the block diagrams.

In a typical configuration, a computing device includes one or more processors (CPU), an input/output interface, a network interface, and a memory.

The memory may include a non-permanent memory in the computer-readable medium, a random access memory (RAM) and/or a nonvolatile memory, such as a read-only memory (ROM) or a flash RAM. The memory is an example of a computer-readable medium.

The computer storage medium is a readable storage medium, which can also be called a readable medium. The readable storage medium includes permanent and non-permanent, removable and non-removable media, which can store information by any method or technology. The information can be a computer-readable instruction, a data structure, a program module or other data. Examples of the computer storage medium include, but not limited to, phase change RAM (PRAM), static random access memory (SRAM), dynamic random access memory (DRAM), other types of random access memory (RAM), read-only memory (ROM), electrically erasable programmable read-only memory (EEPROM), flash memory or other memory technologies, compact disc read-only memory (CD-ROM), digital versatile disc (DVD) or other optical storage, magnetic cassettes, magnetic disk storage or other magnetic storage devices or any other non-transmission medium, which can be used to store information that can be accessed by computing devices. According to the definition in the present application, the computer-readable medium does not include transitory computer-readable media (transitory media), such as modulated data signals and carrier waves.

It should also be noted that the terms “including” and “containing” and any variations thereof are intended to cover non-exclusive inclusion, so that a process, a method, a commodity or a device containing a series of steps or units includes not only those elements, but includes other steps or units not explicitly listed or inherent to such process, method, commodity or device. Without more restrictions, an element defined by the phrase “including a” does not exclude the existence of other identical elements in the process, method, product or device including the element.

The above are only embodiments of the present application, which are not used to limit the present application. It should be noted that for those skilled in the art, there can be various modifications and changes of the present application. Any modifications, equivalent replacements and improvements without departing from the spirit and principle of the present application should be contained in the scope of the appended claims of the present application.

1. A network configuration information processing method suitable for a software defined network (SDN) controller, comprising:
receiving a live migration message provided by a virtual machine management node that a first virtual machine is migrated from a first original node computer to a first destination node computer;
in response to the live migration message, providing a corresponding relationship between the first virtual machine and the first destination node computer to a gateway in a network system, so that a node computer in the network system obtains the corresponding relationship between the first virtual machine and the first destination node computer from the gateway;
delaying sending a configuration information deletion instruction to the first original node computer, so that the first original node computer delays deleting network configuration information of the first virtual machine; and
in a case that a condition for sending the configuration information deletion instruction is met, sending the configuration information deletion instruction to the first original node computer, so that the first original node computer deletes the network configuration information for the first virtual machine.

2. The method according to claim 1, further comprising:
in a case that a current time reaches an execution time of a deletion task, determining that the condition for sending the configuration information deletion instruction is met, wherein a time difference between the execution time of the deletion task and a generation time of the deletion task is greater than or equal to a delay duration for the node computer in the network system to obtain the corresponding relationship between the first virtual machine and the first destination node computer from the gateway, and the deletion task is used to send the configuration information deletion instruction to the first original node computer;
wherein the sending the configuration information deletion instruction to the first original node computer comprises:
in the case that the current time reaches the execution time of the deletion task, executing the deletion task, so as to send the configuration information deletion instruction to the first original node computer.

3. The method according to claim 2, wherein the deletion task comprises an identification of the first original node computer, an identification of the first destination node computer and the network configuration information of the first virtual machine;
wherein before executing the deletion task, the method further comprises:
obtaining the identification of the first destination node computer and the network configuration information of the first virtual machine from the live migration message; and
in a case that a target deletion task exists in an existing deletion task, executing the target deletion task directly, so that the first destination node computer deletes the network configuration information of the first virtual machine, wherein the target deletion task is a deletion task that instructs the first destination node computer to delete the network configuration information of the first virtual machine.

4. The method according to claim 3, further comprising:
obtaining, from the existing deletion task, an identification of a second original node computer and network configuration information of a second virtual machine contained in the existing deletion task, wherein the second virtual machine refers to a virtual machine to be deleted by the existing deletion task;
in a case that an identification of the second virtual machine contains the identification of the first virtual machine, determining whether a virtual machine with the same network configuration information as the first virtual machine exists in the second virtual machine corresponding to the second original node computer; and
if the determination result is yes, determining that the target deletion task exists in the existing deletion task.

5. The method according to claim 2, further comprising:
storing a configuration snapshot of first network configuration information of the first virtual machine before migrating from the first original node computer to the first destination node computer;
wherein the sending the configuration information deletion instruction to the first original node computer comprises:
obtaining the first network configuration information from the configuration snapshot;
determining that the first network configuration information is network configuration information to be deleted; and
generating the configuration information deletion instruction according to the network configuration information to be deleted, so as to instruct the first original node computer to delete the network configuration information to be deleted.

6. The method according to claim 5, further comprising:
obtaining second network configuration information of the first virtual machine from a controller database in response to the live migration message; and
sending the second network configuration information to the first destination node computer so that the first destination node computer performs network configuration on the first virtual machine.

7. The method according to claim 6, further comprising:
updating the network configuration of the first virtual machine to obtain updated network configuration information;
determining the updated network configuration information as the second network configuration information; and
storing the second network configuration information in the controller database.

8. The method according to claim 1, wherein the virtual machine management node sends a relay instruction to the first original node computer when live migration of the first virtual machine starts, in a process of the live migration of the first virtual machine or after the live migration of the first virtual machine is completed, and the relay instruction is used to instruct the first original node computer to relay a message for accessing the first virtual machine to the first destination node computer when the message for accessing the first virtual machine is received;
wherein the first original node computer stores the relay instruction, and relays the message for accessing the first virtual machine received during storing the relay instruction to the first destination node computer.

9. The method according to claim 8, wherein a duration for the first original node computer to store the relay instruction is greater than or equal to a delay duration for the SDN controller to send the configuration information deletion instruction.

10. A network system comprising a virtual machine management node, a software defined network (SDN) controller, a gateway and a plurality of node computers, wherein at least one of the plurality of node computers is deployed with a virtual machine, and the SDN controller communicates with the plurality of node computers through the gateway;
the virtual machine management node is configured to: live migrate a first virtual machine on a first original node computer among the at least one node computer to a first destination node computer, wherein the first destination node computer is another node computer among the plurality of node computers other than the first original node computer; and provides the SDN controller with a live migration message that the first virtual machine is migrated from the first original node computer to the first destination node computer;
the SDN controller is configured to provide a corresponding relationship between the first virtual machine and the first destination node computer to the gateway in the network system in response to the live migration message, so that the plurality of node computers obtains the corresponding relationship between the first virtual machine and the first destination node computer from the gateway;
the SDN controller is further configured to: delay sending an configuration information deletion instruction to the first original node computer, so that the first original node computer delays deleting network configuration information for the first virtual machine; and send the configuration information deletion instruction to the first original node computer in a case that a condition for sending the configuration information deletion instruction is met;
the first original node computer is configured to delete the network configuration information for the first virtual machine according to the configuration information deletion instruction.

11. The system according to claim 10, wherein the virtual machine management node is further configured to:
send a relay instruction to the first original node computer in a process of live migration of the first virtual machine, wherein the relay instruction is used to instruct the first original node computer to relay a message for accessing the first virtual machine to the first destination node computer when the message for accessing the first virtual machine is received.

12. The system according to claim 10, wherein the SDN controller is a virtual private cloud (VPC) controller.

13. A software defined network (SDN) controller, comprising: a memory, a processor and a communication component, wherein the memory is configured to store a computer program;
the processor is coupled to the memory and the communication component and is configured to execute the computer program to:
receive a live migration message provided by a virtual machine management node that a first virtual machine is migrated from a first original node computer to a first destination node computer;
in response to the live migration message, provide a corresponding relationship between the first virtual machine and the first destination node computer to a gateway in a network system, so that a node computer in the network system obtains the corresponding relationship between the first virtual machine and the first destination node computer from the gateway;
delay sending a configuration information deletion instruction to the first original node computer, so that the first original node computer delays deleting network configuration information of the first virtual machine; and
in a case that a condition for sending the configuration information deletion instruction is met, send the configuration information deletion instruction to the first original node computer, so that the first original node computer deletes the network configuration information for the first virtual machine.

14. A non-transitory computer-readable storage medium storing computer instructions, when the computer instructions are executed by one or more processors, the one or more processors are caused to perform the steps in the method of claim 1.

15. The SDN controller according to claim 13, wherein the processor is configured to execute the computer program to:
in a case that a current time reaches an execution time of a deletion task, determine that the condition for sending the configuration information deletion instruction is met, wherein a time difference between the execution time of the deletion task and a generation time of the deletion task is greater than or equal to a delay duration for the node computer in the network system to obtain the corresponding relationship between the first virtual machine and the first destination node computer from the gateway, and the deletion task is used to send the configuration information deletion instruction to the first original node computer; and
in the case that the current time reaches the execution time of the deletion task, execute the deletion task, so as to send the configuration information deletion instruction to the first original node computer.

16. The SDN controller according to claim 15, wherein the deletion task comprises an identification of the first original node computer, an identification of the first destination node computer and the network configuration information of the first virtual machine, and the processor is configured to execute the computer program to:
obtain the identification of the first destination node computer and the network configuration information of the first virtual machine from the live migration message; and
in a case that a target deletion task exists in an existing deletion task, execute the target deletion task directly, so that the first destination node computer deletes the network configuration information of the first virtual machine, wherein the target deletion task is a deletion task that instructs the first destination node computer to delete the network configuration information of the first virtual machine.

17. The SDN controller according to claim 16, wherein the processor is configured to execute the computer program to:
obtain, from the existing deletion task, an identification of a second original node computer and network configuration information of a second virtual machine contained in the existing deletion task, wherein the second virtual machine refers to a virtual machine to be deleted by the existing deletion task;
in a case that an identification of the second virtual machine contains the identification of the first virtual machine, determine whether a virtual machine with the same network configuration information as the first virtual machine exists in the second virtual machine corresponding to the second original node computer; and
if the determination result is yes, determine that the target deletion task exists in the existing deletion task.

18. The SDN controller according to claim 15, wherein the processor is configured to execute the computer program to:
store a configuration snapshot of first network configuration information of the first virtual machine before migrating from the first original node computer to the first destination node computer;
obtain the first network configuration information from the configuration snapshot;
determine that the first network configuration information is network configuration information to be deleted; and
generate the configuration information deletion instruction according to the network configuration information to be deleted, so as to instruct the first original node computer to delete the network configuration information to be deleted.

19. The SDN controller according to claim 18, wherein the processor is configured to execute the computer program to:
obtain second network configuration information of the first virtual machine from a controller database in response to the live migration message; and
send the second network configuration information to the first destination node computer so that the first destination node computer performs network configuration on the first virtual machine.

20. The SDN controller according to claim 19, wherein the processor is configured to execute the computer program to:
update the network configuration of the first virtual machine to obtain updated network configuration information;
determine the updated network configuration information as the second network configuration information; and
store the second network configuration information in the controller database.
